(19) United States
(12) Patent Application Publication
(10) Pub. No.: US 2022/0006905 A1
(43) Pub. Date: Jan. 6, 2022

(54) METHOD FOR MONITORING THE USE OF RESOURCES IN AT LEAST ONE CELL OF A RADIO COMMUNICATIONS NETWORK

(71) Applicant: Orange, Paris (FR)

(72) Inventors: Julien Giannandrea, Chatillon Cedex (FR); Simon Bertrand, Chatillon Cedex (FR); José Pirlot, Chatillon Cedex (FR)

(21) Appl. No.: 17/299,514

(22) PCT Filed: Nov. 27, 2019
(86) PCT No.: PCT/FR2019/052817

§ 371 Date: Jun. 3, 2021

(30) Foreign Application Priority Data
Dec. 5, 2018 (FR) 1872333

(51) Int. Cl. H04M 15/00

(52) U.S. Cl. CPC H04M 15/60; H04M 15/66; H04M 15/58; H04M 15/61; H04M 15/81; H04M 15/8027; H04M 15/85; H04M 15/62; H04M 15/84

(57) ABSTRACT

In order best to exploit their investments, some telecommunication operators implement yield management solutions. The yield management solutions implemented make it possible to dynamically adapt the tariff offers associated with certain services provided with a level of use of the resources, or load, of the telecommunication networks involved. However, such solutions are expensive since they require introducing numerous items of equipment in the telecommunication network and they give an unsatisfactory level of responsiveness. The solution is in collecting information relating to the use of the resources of the communication network for cells constituting the radio communication network for mobile terminals identified. Consequently, the information relating to the use of the resources thus collected allows yield management solutions to be applied accurately for each mobile terminal monitored according to the location thereof in the radio communication network.

### CROSS-REFERENCE TO RELATED APPLICATIONS

This application is filed under 35 U.S.C. § 371 as the U.S. National Phase of Application No. PCT/FR2019/052817 entitled “METHOD FOR MONITORING THE USE OF RESOURCES IN AT LEAST ONE CELL OF A RADIO COMMUNICATIONS NETWORK” and filed Nov. 27, 2019, and which claims priority to FR 1872333 filed Dec. 5, 2018, each of which is incorporated by reference in its entirety.

### BACKGROUND

### Field

The invention relates to the field of yield management applied to telecommunications. More particularly, the invention relates to methods and equipment for implementing yield management solutions in radio communication networks.

### Description of the Related Technology

In order best to exploit their investments, and in particular the frequency-band licenses and equipment used in radio communication networks, some telecommunication operators are led to implement yield management solutions.

Yield management is a method for the tariff management of available capacities. The objective of yield management is to maximize the receipts of a service business. Yield management solutions make it possible to identify market segments, to evaluate the potentials thereof and to determine prices. Yield management solutions also make it possible to create tariff reduction rules and to monitor the efficacy and implementation thereof. Finally, such solutions provide management of the available capacity through pricing and an offer of services adapted to the specificity of each identified customer segment.

In the field of telecommunications, the yield management solutions implemented make it possible to dynamically adapt the tariff offers associated with certain services provided by the telecommunication operators through their communication networks according to a level of use of the resources, or load, of the telecommunication networks involved.

For example, when a telecommunication network of a telecommunication operator is at nominal load or when it is overloaded, that is to say when the resources of the communication network are being used beyond a nominal use, the telecommunication operator applies the contractual tariff of the offer of service. When the communication network is underloaded, i.e. when the resources of the communication network are underused, the telecommunication operator can apply tariffs that are more advantageous for its users for the same offer of service in order to encourage them to use more of the resources of the telecommunication network during this period of underloading. Thus the user experience is improved without any additional investment on the part of the telecommunication operator.

In order to be able to implement such management solutions in a telecommunication network, a plurality of solutions are offered to the telecommunication operators.

A first solution consists in introducing sensors in the telecommunication network in order to monitor the load on the telecommunication network. The data harvested by the various sensors are then collected and processed in order to determine the state of load of the telecommunication network.

However, such a solution is expensive since it requires introducing numerous items of equipment, the sensors, in the communication network and gives an unsatisfactory level of responsiveness related to the fact that the data coming from the sensors must be processed globally in order to be able to be used for purposes of yield management.

A second solution consists in predicting periods during which the communication network is loaded or underloaded by means of statistics of use of the communication network resources.

Such a solution does not provide real-time knowledge of a state of load of the communication network. Applying such a solution may for example lead a telecommunication operator to apply a tariff for the services provided corresponding to a state of underloading of the communication network whereas the latter is actually in a state of nominal load or a state of overload.

Therefore, there is a need for a technique for collecting information related to a state of loading of a communication network making it possible to improve the implementation of yield management solutions.

### SUMMARY OF CERTAIN INVENTIVE ASPECTS

The invention responds to this need by proposing a method for detecting underuse of the resources of at least one area to be monitored comprising at least one cell constituting a radio communication network, the method being implemented by an equipment monitoring the use of the resources of the radio communication network and comprising the following steps of:
receiving, coming from an invoicing-rules management equipment, at least one identifier of said area to be monitored, and an identifier of at least one mobile terminal to be monitored present in said area to be monitored,
detecting underuse of the resources of said area,
transmitting, to the invoicing-rules management equipment, the identifier of the area to be monitored, a parameter indicating underuse of the resources of the area to be monitored and the identifier of said mobile terminal to be monitored.

Such a detection method makes it possible to collect information related to a state of loading of a communication network making it possible to improve the implementation of yield management solutions. This is because the solution that is the object of the invention consists in collecting information relating to the use of the resources of the communication network for cells constituting the radio communication network and for mobile terminals identified by the telecommunication operator responsible for operating the radio communication network. Consequently, the information relating to the use of the resources thus collected, allows the yield management solutions to be applied accurately for each mobile terminal monitored, according to the location thereof in the radio communication network.

According to one feature of the detection method, the determination step consists in a comparison of a value representing the use of the resources of said area to be monitored with a threshold of underuse of the resources.

The underuse threshold is determined by the telecommunication operator operating the radio communication network. Such an underuse threshold is particular to each area to be monitored and may, for the same area to be monitored, take various values over time according to the requirements of the telecommunication operator operating the radio communication network.

According to one feature of the detection method, the underuse threshold of the resources is received during the reception step.

The equipment monitoring the use of the resources of the radio communication network receives a new underuse threshold value each time it receives monitoring information coming from the invoicing-rules management equipment. Thus the equipment monitoring the use of the resources of the radio communication network systematically uses the most recent value of the monitoring threshold to detect underuse of the resources of the area to be monitored.

According to one feature of the detection method, the value representing the use of the resources of said area to be monitored is a mean value of the use of the resources of said area to be monitored.

By calculating a mean value of the use of the resources of the area to be monitored, the equipment monitoring the use of the resources of the radio communication network ensures that an isolated peak of use of the resources of the area to be monitored is not transmitted to the invoicing-rules management equipment and is not used in the context of yield management.

According to one feature of the detection method, the detection of an underuse of the resources of said area triggers the sending, to an equipment monitoring the mobility of the mobile terminals, of a request to obtain identifiers of the mobile terminals present in the area to be monitored, the detection method further comprises a step of: identifying the identifier of the at least one mobile terminal to be monitored among the identifiers of the mobile terminals present in the area to be monitored.

The equipment monitoring the use of the resources of the area to be monitored repeatedly receives information relating to the use of the resources of the area to be monitored as well as a list of all the mobile terminals present in the area to be monitored. When underuse of the resources of the area to be monitored is detected, the equipment monitoring the use of the resources of the area to be monitored runs through the list of mobile terminals present in the area to be monitored in order to identify the terminals to be monitored present in the area to be monitored.

According to one feature of the detection method, the latter further comprises the following steps of:
detecting a nominal use of the resources of said area, transmitting, to the invoicing-rules management equipment, the identifier of the area to be monitored, a parameter indicating the nominal use of the resources of the area to be monitored and the identifier of said mobile terminal to be monitored.

When the resources of the area to be monitored are once again used nominally, the equipment monitoring the use of the resources of the area to be monitored informs the invoicing-rules management equipment thereof.

According to one feature of the detection method, the area to be monitored comprising at least two cells constituting the radio communication network, the equipment monitoring the use of the resources of the radio communication network detects underuse of the resources of the area to be monitored when the resources of the at least two cells constituting the radio communication network included in the area to be monitored are simultaneously underused.

According to one feature of the detection method, the equipment for monitoring the use of the resources of the radio communication network detects nominal use of the resources of the area to be monitored when the resources of at least one of the two cells constituting the radio communication network included in the area to be monitored are being used nominally.

Another object of the invention is a method for collecting data relating to underuse of the resources of at least one area to be monitored comprising at least one cell constituting a radio communication network, the method being implemented by invoicing-rules management equipment and comprising the following steps of:
receiving, coming from an equipment managing the mobility of the mobile terminals, an identifier of at least one mobile terminal present in the area to be monitored and an identifier of said area to be monitored, determining parameters for activating the monitoring of said area to be monitored and of said mobile terminal to be monitored according to invoicing rules applicable to said mobile terminal, when the activation parameters meet monitoring-activation conditions, transmitting, to an equipment monitoring the use of the resources of the radio communication network, at least one identifier of said area to be monitored, and the identifier of the at least one mobile terminal to be monitored present in said area to be monitored, receiving, coming from the equipment monitoring the use of the resources of the radio communication network, the identifier of the area to be monitored, a parameter indicating underuse of the resources of the area to be monitored and the identifier of said mobile terminal to be monitored, determining, according to invoicing rules, a tariff policy to be applied to the user of said mobile terminal to be monitored.

The invention also relates to an equipment for monitoring the use of the resources of a radio communication network capable of detecting underuse of the resources of at least one area to be monitored comprising at least one cell constituting the radio communication network, the equipment for monitoring comprising means for: receiving, coming from invoicing-rules management equipment, at least one identifier of said area to be monitored, and an identifier of at least one mobile terminal to be monitored present in said area to be monitored, detecting underuse of the resources of said area, transmitting, to the invoicing-rules management equipment, the identifier of the area to be monitored, a parameter indicating underuse of the resources of the area to be monitored and the identifier of said mobile terminal to be monitored.

Such equipment for monitoring the use of the resources of the area to be monitored is for example an equipment of the RCAF (RAN Congestion Awareness Function) type, as defined in the technical specification TS 23.203 published by the 3GPP (Third Generation Partnership Project), and modified so as to be able to implement the solution that is the object of the invention.

The invention also relates to invoicing-rules management equipment capable of collecting data relating to underuse of the resources of at least one area to be monitored comprising at least one cell constituting a radio communication network, the invoicing-rules management equipment comprising means for:
receiving, coming from an equipment for managing the mobility of the mobile terminals, an identifier of at least one mobile terminal present in the area to be monitored and an identifier of said area to be monitored,
determining parameters for activating the monitoring of said area to be monitored and of said mobile terminal to be monitored according to invoicing rules applicable to said mobile terminal,
when the activation parameters meet conditions for activation of the monitoring, transmitting, to equipment monitoring the use of the resources of the radio communication network, at least one identifier of said area to be monitored, and the identifier of the at least one mobile terminal to be monitored present in said area to be monitored,
receiving, coming from the equipment monitoring the use of the resources of the radio communication network, the identifier of the area to be monitored, a parameter indicating the underuse of the resources of the area to be monitored and the identifier of said mobile terminal to be monitored,
determining, according to invoicing rules, a tariff policy to be applied to the user of said mobile terminal to be monitored.

Such invoicing-rules management equipment is for example an equipment of the PCRF (Policy and Charging Rules Function) type, as defined in the technical specification TS 23.203 published by the 3GPP (Third Generation Partnership Project), and modified so as to be able to implement the solution that is the object of the invention.

Finally, the invention relates to computer program products comprising program code instructions for implementing the methods as described above, when they are executed by a processor.

The invention also relates to a recording medium that can be read by a computer whereon computer programs are recorded, comprising program code instructions for executing the steps of the methods according to the invention as described above.

Such a recording medium may be any entity or device capable of storing the programs. For example, the medium may include a storage means, such as a ROM, for example a CD-ROM or a microelectronic-circuit ROM, a USB stick, or a magnetic recording means, for example a hard disk.

Moreover, such a recording medium may be a transmissible medium such as an electrical or optical signal, which may be conveyed via an electrical or optical cable, by radio or by other means, so that the computer programs that it contains are remotely executable. The programs according to the invention may, in particular, be downloaded from a network, for example the internet.

Alternatively, the recording medium may be an integrated circuit wherein the programs are incorporated, the circuit being adapted to execute or to be used in the execution of the methods that are the aforementioned objects of the invention.

### BRIEF DESCRIPTION OF THE DRAWINGS

Other aims, features and advantages of the invention will emerge more clearly from the reading of the following description, given by way of simple illustrative and non-limitative example, in relation to the figures, among which:

FIG. 1: it shows schematically a network architecture wherein the solution that is the object of the invention is implemented,

FIG. 2: it shows the various steps implemented by the various items of equipment in the radio communication network involved in implementing the solution that is the object of the invention,

FIG. 3: it shows equipment for monitoring the use of the resources of the area to be monitored according to one embodiment of the invention,

FIG. 4: it shows invoicing-rules management equipment according to one embodiment of the invention.

### DETAILED DESCRIPTION OF CERTAIN ILLUSTRATIVE EMBODIMENTS

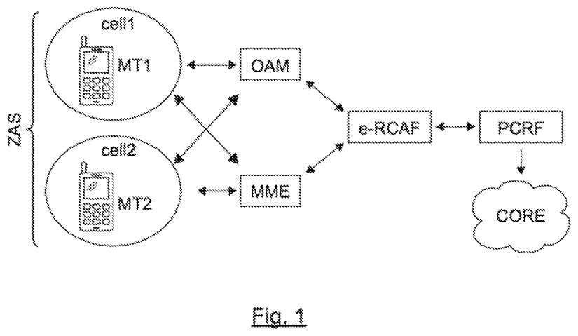

FIG. 1 shows schematically a network architecture wherein the solution that is the object of the invention is implemented.

A radio communication network comprises a plurality of cells each comprising at least one base station (not shown in the figure) to which one or more mobile terminals are attached.

An area to be monitored ZAS is shown in FIG. 1 and comprises two cells cell1 and cell2 constituting the radio communication network. The communication network comprises a plurality of areas to be monitored and an area to be monitored ZAS may comprise one or more cells according to the requirements of the telecommunication operator operating the radio communication network.

A mobile terminal MT1 is present in the cell cell1 and a mobile terminal MT2 is present in the cell cell2. Naturally a plurality of terminals may be present simultaneously in the same cell.

An equipment for managing the mobility of the mobile terminals MME located in the radio communication network knows the identifiers of the mobile terminals MT1 and MT2 present in the cells cell1 and cell2 and regularly transmits, to other equipment present in the radio communication network, the identifiers of the mobile terminals actually present in a given cell.

An equipment OAM for managing operations, administration and maintenance, located in the radio communication network, repeatedly collects information relating to the level of use of the resources of the cells cell1 and cell2, such as for example a level of use of the bandwidth.

The equipment MME for managing the mobility of the mobile terminals and the equipment OAM for managing operations, administration and maintenance communicate with an equipment e-RCAF for monitoring the use of the resources of the area to be monitored, to which they repeatedly transmit the information relating to the mobile terminals MT1 and MT2 and to the cells cell1 and cell2 that they have collected.

The equipment e-RCAF for monitoring the use of the resources of the area to be monitored also communicates with invoicing-rules management equipment PCRF itself connected to the network core CORE.

In one embodiment of the invention, the equipment MME for managing the mobility of the mobile terminals corresponds to an equipment of the MME (Mobility Management Entity) type, as defined in series 23 of the technical specifications of the 3GPP.

The equipment OAM for managing operations, administration and maintenance corresponds to an equipment of the OAM (Operation, Administration and Maintenance) type, as defined in series 32 of the technical specifications of the 3GPP.

The equipment for monitoring the use of the resources of the area to be monitored is an equipment of the RCAF (RAN Congestion Awareness Function) type as defined in the technical specification TS 23.203 published by the 3GPP, and modified so as to be able to implement the solution that is the object of the invention. Indeed, the equipment e-RCAF for monitoring the use of the resources of the area to be monitored is capable of managing information relating to the level of use of the resources of the area to be monitored and of the areas to be monitored ZAS.

Finally, the invoicing-rules management equipment is for example an equipment of the PCRF (Policy and Charging Rules Function) type, as defined in the technical specification TS 23.203 published by the 3GPP, and modified so as to be able to implement the solution that is the object of the invention.

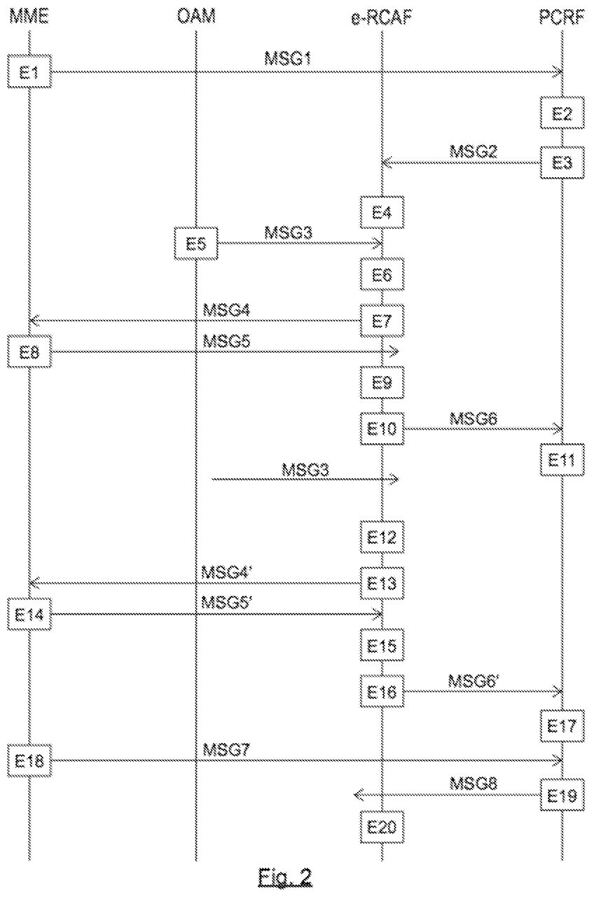

FIG. 2 shows the various steps implemented by the various items of equipment of the radio communication network involved in implementing the solution that is the object of the invention.

In a step E1, the equipment MME for managing the mobility of the mobile terminals sends a first message MSG1 to the invoicing-rules management equipment PRCF informing it of the presence of the mobile terminal MT1 in the cell cell1. The sending of the message MSG1 is for example triggered by the finalisation of the procedure for attaching the mobile terminal MT1 to the base station of the cell cell1. Thus the message MSG1 comprises an identifier of the mobile terminal MT1 and an identifier of the cell cell1.

In response to the message MSG1, the invoicing-rules managing equipment PRCF defines a presence area or PRA, standing for “Presence Reporting Area”, as defined in the technical specification TS 23.401 published by the 3GPP. Such a presence area PRA comprises at least the cell cell1. The invoicing-rules management equipment PRCF then transmits the identifier of the presence area or PRA and of the cells constituting it to the equipment MME for managing the mobility of the mobile terminals, thus activating the presence area or PRA. In this first embodiment, the presence area or PRA corresponds to the area to be monitored ZAS. This is because, in this first embodiment, the presence area or PRA and the area to be monitored ZAS consist of the same cells. The use of the presence areas or PRA makes it possible to limit the exchanges of signalling messages between the various items of equipment involved in implementing the method that is the object of the invention.

In a second embodiment of the method that is the object of the invention, in response to the message MSG1, the invoicing-rules management equipment PRCF defines the area to be monitored ZAS. The invoicing-rules management equipment PRCF then transmits an identifier of the area to be monitored and of the cells constituting it to the equipment e-RCAF for monitoring the use of the resources of the area to be monitored.

During a step E2, the invoicing-rules management equipment PRCF determines parameters of activation of the monitoring of an area to be monitored ZAS comprising the cell cell1 and of the mobile terminal MT1 to be monitored and checks that the activation parameters thus determined meet conditions for activating the monitoring of an area to be monitored comprising the cell cell1 and the mobile terminal MT1. The activation parameters comprise among other things: the policy of the telecommunications operator operating the radio communication network, the subscription conditions of a user of the mobile terminal MT1. The area to be monitored ZAS is identified by the invoicing-rules management equipment PCRF according to the identifier of the presence area or PRA or the identifier of the cell cell1 depending on whether the method is implemented in accordance with the first or the second embodiment.

The area to be monitored ZAS was previously created by the invoicing-rules management equipment PRCF using information provided by the telecommunications operator operating the radio communication network and related, among other things, to the yield management solution implemented in the radio communication network.

If the parameters for activating the monitoring are met. i.e. if the user of the mobile terminal MT1 can benefit from the yield management solutions established by the telecommunication operator operating the radio communication network, the invoicing-rules management equipment PCFR transmits a message MSG2 to the equipment e-RCAF for monitoring the use of the resources of the area to be monitored during a step E3. The message MSG2 comprises an identifier of the area to be monitored ZAS, the identifier of the cell cell1 and an identifier of the cell cell2 constituting the area to be monitored ZAS, the identifier of the mobile terminal MT1 to be monitored and, where applicable, a value of a threshold S of underuse of the resources of the area to be monitored ZAS.

In a step E4, on reception of the message MSG2, the equipment e-RCAF for monitoring the use of the resources of the area to be monitored associates, in a storage unit 302, the identifier of the area to be monitored ZAS and the identifiers of the cells cell1, cell2 that constitute it, with the value of the threshold S of underuse of the resources of the area to be monitored and the identifier of the mobile terminal MT1 to be monitored.

When a second mobile terminal MT2 attaches itself to the base station of the cell ce112 forming part of the area to be monitored ZAS, the steps E1 to E4 are once again implemented.

In a step E5, the equipment OAM for managing operations, administration and maintenance sends a message MSG3 to the equipment e-RCAF for monitoring the use of the resources of the area to be monitored. The message MSG3 is sent for example every five minutes and comprises information relating to the use of the resources in each of the cells cell1 and cell2 constituting the area to be monitored ZAS. The step E5 is implemented repeatedly by the equipment OAM for managing operations, administration and maintenance as long as it is in operation.

In a step E6, the equipment e-RCAF for monitoring the use of the resources of the area to be monitored compares the values relating to the use of the resources in each of the cells cell1 and cell2 received during the step E5 with the value of the threshold S of underuse of the resources of the area to be monitored.

If the value relating to the use of the resources in the cell cell1 and the value relating to the use of the resources in the cell cell2 are both lower than the value of the threshold S of underuse of the resources of the area to be monitored, the equipment e-RCAF for monitoring the use of the resources of the area to be monitored determines that the resources of the area to be monitored ZAS are underused.

In one embodiment of the method that is the object of the invention, the value representing the use of the resources of said area to be monitored is a mean value of the use of the resources of said area to be monitored calculated by the equipment e-RCAF for monitoring the use of the resources of the area to be monitored according to the information contained in the message MSG3.

By calculating a mean value of the use of the resources of the area to be monitored, the equipment for monitoring the use of the resources of the radio communication network ensures that an isolated peak of use of the resources of the area to be monitored is not transmitted to the invoicing-rules management equipment and is not used in the context of yield management.

In another implementation of the method that is the object of the invention, in order to avoid the phenomena of rapid oscillations between two states, underuse of the resources and nominal use of the resources, the equipment e-RCAF for monitoring the use of the resources of the area to be monitored defines a low crossing threshold and a high crossing threshold around the value of the threshold S of underuse of the resources of the area to be monitored.

The equipment e-RCAF for monitoring the use of the resources of the area to be monitored then transmits, to the equipment MME for managing the mobility of the mobile terminals, a message MSG4 comprising a request to obtain the identifiers of the mobile terminals present in the area to be monitored ZAS during a step E7.

In a step E8, the equipment MME for managing the mobility of the mobile terminals then transmits a message MSG5 comprising a list comprising the identifiers of the mobile terminals present in the cells cell1 and cell2 of the area to be monitored ZAS. The mobile terminals present in a cell are the mobile terminals that are actually attached to the base stations of the cells cell1 and cell2 of the area to be monitored.

In the first embodiment of the method that is the object of the invention, the steps E7 and E8 are optional and may not be implemented since the equipment e-RCAF for monitoring the use of the resources of an area to be monitored keeps up to date a list of the mobile terminals MT1 and MT2 to be monitored and which are present in the area to be monitored ZAS. Implementing the steps E7 and E8 improves the reliability of the information relating to the presence of the mobile terminals MT1 and MT2 to be monitored in the area to be monitored ZAS.

In the second embodiment of the method that is the object of the invention, the steps E7 and E8 are implemented repeatedly for as long as the resources of the area to be monitored ZAS are underused.

In a step E9, the equipment e-RCAF for monitoring the use of the resources of an area to be monitored runs through the list of mobile terminals present in the area to be monitored ZAS in order to identify the mobile terminals MT1 and MT2 to be monitored present in the area to be monitored by means of the identifiers thereof and thus to confirm the presence thereof in the area to be monitored ZAS.

The equipment e-RCAF for monitoring the use of the resources of an area to be monitored sends, in a step E10, a message MSG6 to the invoicing-rules management equipment PCRF. The message MSG6 comprises the identifier of the area to be monitored ZAS, a parameter PSU indicating underuse of the resources of the area to be monitored ZAS and the identifier of the mobile terminals MT1 and MT2 to be monitored.

In a step E11, the invoicing-rules management equipment PCRF determines, according to the policy of the telecommunications operator operating the radio communication network, subscription conditions of the users of the mobile terminals MT1 and MT2 and information contained in the message MSG6, which tariff policy to apply to the users of the mobile terminals MT1 and MT2 to be monitored.

In a step E12, the equipment c-RCAF for monitoring the use of the resources of the area to be monitored compares values relating to the use of the resources in each of the cells cell1 and cell2 received in a new message MSG3 sent repeatedly by the equipment OAM for managing operations, administration and maintenance with the value of the threshold S of underuse of the resources of the area to be monitored. Since the last comparison made during the step E6, the value of the threshold S of underuse of the resources of the area to be monitored may have changed.

If the value relating to the use of the resources in the cell cell1 or the value relating to the use of the resources in the cell cell2 is higher than the value of the threshold S of underuse of the resources of the area to be monitored, the equipment e-RCAF for monitoring the use of the resources of the area to be monitored determines that the resources of the area to be monitored ZAS are being used nominally or are overused.

In one embodiment of the method that is the object of the invention, the value representing the use of the resources of said area to be monitored is a mean value of the use of the resources of said area to be monitored calculated by the equipment e-RCAF for monitoring the use of the resources of the area to be monitored according to the information contained in the message MSG3.

By calculating a mean value of the use of the resources of the area to be monitored, the equipment for monitoring the use of the resources of the radio communication network ensures that an isolated peak of use of the resources of the area to be monitored is not transmitted to the invoicing-rules management equipment and is not used in the context of yield management.

In another implementation of the method that is the object of the invention, in order to avoid the phenomena of rapid oscillations between two states, underuse of the resources and nominal use of the resources, the equipment e-RCAF for monitoring the use of the resources of the area to be monitored defines a low crossing threshold and a high crossing threshold around the value of the threshold S of underuse of the resources of the area to be monitored.

The equipment e-RCAF for monitoring the use of the resources of the area to be monitored then transmits, to the equipment MME for managing the mobility of the mobile terminals, a message MSG4′ comprising a request to obtain the identifiers of the mobile terminals present in the area to be monitored ZAS during a step E13.

In a step E14, the equipment MME for managing the mobility of the mobile terminals then transmits a message MSG5′ comprising a list comprising the identifiers of the mobile terminals present in the cells cell1 and cell2 of the area to be monitored ZAS.

In the first embodiment of the method that is the object of the invention, the steps E13 and E14 are optional and may not be implemented since the equipment e-RCAF for monitoring the use of the resources of an area to be monitored keeps up to date a list of the mobile terminals MT1 and MT2 to be monitored and which are present in the area to be monitored ZAS.

In the second embodiment of the method that is the object of the invention, the steps E7 and E8 are not optional and are therefore implemented systematically.

In a step E15, the equipment e-RCAF for monitoring the use of the resources of an area to be monitored runs through the list of mobile terminals present in the area to be monitored ZAS in order to identify the mobile terminals MT1 and MT2 to be monitored present in the area to be monitored by means of the identifiers thereof and thus to confirm the presence thereof in the area to be monitored ZAS.

The equipment e-RCAF for monitoring the use of the resources of the area to be monitored sends, in a step E16, a message MSG6′ to the invoicing-rules management equipment PCRF. The message MSG6′ comprises the identifier of the area to be monitored ZAS, a parameter PN indicating the use in nominal mode of the resources of the area to be monitored ZAS and the identifier of the mobile terminals MT1 and MT2 to be monitored.

In a step E17, the invoicing-rules management equipment PCRF determines, according to the policy of the telecommunications operator operating the radio communication network, to the subscription conditions of the users of the mobile terminals MT and MT2 and to information contained in the message MSG6, which tariff policy to apply to the users of the mobile terminals MT1 and MT2 to be monitored.

According to the use of the resources in the cells cell1 and cell2 of the area to be monitored ZAS, the steps E6 to E11 and E12 to E17 are alternately implemented, allowing better application of the yield management solutions of the telecommunications operator operating the radio communication module.

When one of the mobile terminals to be monitored MT1, MT2 leaves the cell cell1 or cell2 wherein it was present, the equipment MME for managing the mobility of the mobile terminals sends, in a step E18, a message MSG7 to the invoicing-rules management equipment PRCF informing it of the departure of the mobile terminal MT1 from the cell cell1. The sending of the message MSG7 is for example triggered by the finalisation of a procedure of handover of the mobile terminal MT1 from the base station of the cell cell1. Thus the message MSG7 comprises an identifier of the mobile terminal MT1 and an identifier of the cell cell1.

During a step E19, the invoicing-rules management equipment PRCF transmits a message MSG8 to the equipment e-RCAF for monitoring the use of the resources of the area to be monitored comprising the identifier of the area to be monitored ZAS, the identifier of the cell cell1 and the identifier of the mobile terminal MT1 to be monitored and a parameter P indicating that it is necessary to stop monitoring the mobile terminal MT1.

In a step E20, on receipt of the message MSG8, the equipment e-RCAF for monitoring the use of the resources of the area to be monitored deletes the association of the identifier of the area to be monitored ZAS and the identifiers of the cells cell1, cell2 that constitute it with the value of the threshold S of underuse of the resources of the area to be monitored and the identifier of the mobile terminal MT1 to be monitored from its memory.

When there is no longer any mobile terminal to be monitored in the area to be monitored ZAS, the equipment for monitoring the use of the resources of the area to be monitored stops monitoring the area to be monitored ZAS.

FIG. 3 shows an equipment e-RCAF for monitoring the use of the resources of the area to be monitored according to one embodiment of the invention. Such equipment e-RCAF for monitoring the use of the resources of the area to be monitored is able to implement all the steps of the method described with reference to FIG. 2.

An equipment e-RCAF for monitoring the use of the resources of the area to be monitored may comprise at least one hardware processor 301, a storage unit 302, an input device 303, a display device 304, an interface 305, and at least one network interface 306, which are connected together through a bus 307. Naturally the elements constituting the equipment e-RCAF for monitoring the use of the resources of the area to be monitored may be connected by means of a connection other than a bus.

The processor 301 controls the operations of the equipment e-RCAF for monitoring the use of the resources of the area to be monitored. The storage unit 302 stores at least one program for implementing the monitoring method according to one embodiment of the invention to be executed by the processor 301, and various data, such as parameters used for calculations made by the processor 301, intermediate data of calculations made by the processor 301, etc. The processor 301 may be formed by any known suitable hardware or software, or by a combination of hardware and software. For example, the processor 301 may be formed by dedicated hardware such as a processing circuit, or by a programmable processing unit such as a central processing unit that executes a program stored in a memory thereof.

The storage unit 302 may be formed by any suitable means capable of storing the program or programs and data in a manner that can be read by a computer. Examples of storage unit 302 comprise non-transient storage media that can be read by computer such as semiconductor memory devices, and magnetic, optical or magneto-optical recording media loaded in a read and write unit.

The input device 303 may be formed by a keypad or a pointing device such as a mouse to be used by a user for entering commands. The display device 304 may also be formed by a display module, such as for example a graphical user interface or GUI.

The interface 305 provides an interface between the equipment e-RCAF for monitoring the use of the resources of the area to be monitored and the equipment MME for managing the mobility of the mobile terminals. The interface 305 may communicate with the external apparatus via a wireless connection.

At least one network interface 306 provides a connection between the equipment e-RCAF for monitoring the use of the resources of the area to be monitored and the invoicing-rules management equipment PCRF.

Such equipment for monitoring the use of the resources of the area to be monitored is for example an equipment of the RCAF type, as defined in the technical specification TS 23.203 published by the 3GPP, and modified so as to be able to implement the solution that is the object of the invention.

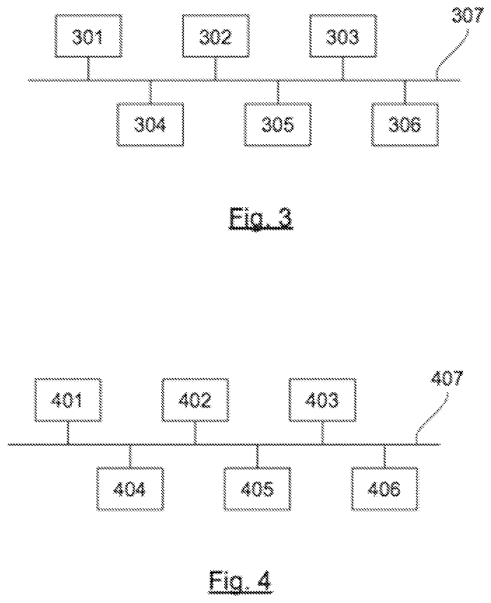

FIG. 4 shows invoicing-rules management equipment PCRF according to one embodiment of the invention. Such invoicing-rules management equipment PCRF is able to implement all the steps of the method described with reference to FIG. 2.

Invoicing-rules management equipment PCRF may comprise at least one hardware processor 401, a storage unit 402, an input device 403, a display device 404, an interface 405, and at least one network interface 406, which are connected together through a bus 407. Naturally the elements constituting the invoicing-rules management equipment PCRF may be connected by means of a connection other than a bus.

The processor 401 controls the operations of the invoicing-rules management equipment PCRF. The storage unit 402 stores at least one program for implementing a data collection method according to one embodiment of the invention to be executed by the processor 401, and various data, such as parameters used for calculations made by the processor 401, intermediate data of calculations made by the processor 401, etc. The processor 401 may be formed by any known suitable hardware or software, or by a combination of hardware and software. For example, the processor 401 may be formed by dedicated hardware such as a processing circuit, or by a programmable processing unit such as a central processing unit that executes a program stored in a memory thereof.

The storage unit 402 may be formed by any suitable means capable of storing the program or programs and data in a manner that can be read by a computer. Examples of a storage unit 402 comprise non-transient storage media that can be read by computer such as semiconductor memory devices, and magnetic, optical or magneto-optical recording media loaded into a read and write unit.

The input device 403 may be formed by a keypad or a pointing device such as a mouse to be used by a user for entering commands. The display device 404 may also be formed by a display module, such as for example a graphical user interface or GUI.

The interface 405 provides an interface between the invoicing-rules management monitoring equipment PCRF and the equipment e-RCAF for monitoring the use of the resources of an area to be monitored. The interface 405 may communicate with the external apparatus by a wireless connection.

At least one network interface 406 provides a connection between the invoicing-rules management equipment PCRF and the core network CORE.

Such invoicing-rules management equipment is for example an equipment of the PCRF type, as defined in the technical specification TS 23.203 published by the 3GPP, and modified in order to be able to implement the solution that is the object of the invention.

1. A detection method of detecting underuse of resources of at least one area to be monitored comprising at least one cell constituting a radio communication network, the detection method being implemented by an equipment monitoring use of the resources of the radio communication network and comprising:
receiving, coming from an invoicing-rules management equipment, at least one identifier of the area to be monitored, and an identifier of at least one mobile terminal to be monitored present in the area to be monitored;
detecting underuse of the resources of the area; and
transmitting, to the invoicing-rules management equipment, the identifier of the area to be monitored, a parameter indicating underuse of the resources of the area to be monitored and the identifier of the mobile terminal to be monitored.

2. The detection method of claim 1, wherein the detecting step comprises in a comparison of a value representing the use of the resources of the area to be monitored with a threshold of underuse of the resources.

3. The detection method of claim 2, wherein the threshold of underuse of the resources is received during the receiving step.

4. The detection method of claim 2, wherein the value representing the use of the resources of the area to be monitored is a mean value of the use of the resources of the area to be monitored.

5. The detection method of claim 1, wherein, the detection of an underuse of the resources of the area triggers sending, to an equipment monitoring a mobility of the mobile terminals, of a request to obtain identifiers of the mobile terminals present in the area to be monitored, the detection method further comprises:
identifying the identifier of at least one mobile terminal to be monitored among the identifiers of the mobile terminals present in the area to be monitored.

6. The detection method of claim 1, further comprising:
detecting a nominal use of the resources of the area; and
transmitting, to the invoicing-rules management equipment, the identifier of the area to be monitored, a parameter indicating the nominal use of the resources of the area to be monitored and the identifier of the mobile terminal to be monitored.

7. The detection method of claim 1, wherein, the area to be monitored comprises at least two cells constituting the radio communication network, the equipment monitoring the use of the resources of the radio communication network detects underuse of the resources of the area to be monitored when the resources of the at least two cells constituting the radio communication network included in the area to be monitored are simultaneously underused.

8. The detection method of claim 7, wherein the equipment for monitoring the use of the resources of the radio communication network detects nominal use of the resources of the area to be monitored when the resources of at least one of the two cells constituting the radio communication network included in the area to be monitored are being used nominally.

9. A collection method of collecting data relating to underuse of resources of at least one area to be monitored comprising at least one cell constituting a radio communication network, the collection method being implemented by invoicing-rules management equipment and comprising:
receiving, coming from equipment managing a mobility of the mobile terminals, an identifier of at least one mobile terminal present in the area to be monitored and an identifier of the area to be monitored;
determining parameters for activating monitoring of the area to be monitored and of the mobile terminal to be monitored according to invoicing rules applicable to the mobile terminal;
when the activation parameters meet monitoring-activation conditions, transmitting, to an equipment monitoring use of the resources of the radio communication network, at least one identifier of the area to be monitored, and the identifier of the at least one mobile terminal to be monitored present in the area to be monitored;
receiving, coming from the equipment monitoring the use of the resources of the radio communication network, the identifier of the area to be monitored, a parameter indicating underuse of the resources of the area to be monitored and the identifier of the mobile terminal to be monitored; and
determining, according to invoicing rules, a tariff policy to be applied to the user of the mobile terminal to be monitored.

10. An equipment for monitoring use of resources of a radio communication network capable of detecting underuse of the resources of at least one area to be monitored comprising at least one cell constituting the radio communication network, the equipment for monitoring comprising means for:
receiving, coming from invoicing-rules management equipment, at least one identifier of the area to be monitored, and an identifier of at least one mobile terminal to be monitored present in the area to be monitored;
detecting underuse of the resources of the area; and
transmitting, to the invoicing-rules management equipment, the identifier of the area to be monitored, a parameter indicating underuse of the resources of the area to be monitored and the identifier of the mobile terminal to be monitored.

11. An invoicing-rules management equipment capable of collecting data relating to underuse of resources of at least one area to be monitored comprising at least one cell constituting a radio communication network, the invoicing-rules management equipment comprising means for:
receiving, coming from an equipment for managing mobility of mobile terminals, an identifier of at least one mobile terminal present in the area to be monitored and an identifier of the area to be monitored;
determining parameters for activating monitoring of the area to be monitored and of the mobile terminal to be monitored according to invoicing rules applicable to the mobile terminal;
when the activation parameters meet conditions for activation of the monitoring, transmitting, to an equipment monitoring use of the resources of the radio communication network, at least one identifier of the area to be monitored, and the identifier of the at least one mobile terminal to be monitored present in the area to be monitored;
receiving, coming from the equipment monitoring the use of the resources of the radio communication network, the identifier of the area to be monitored, a parameter indicating the underuse of the resources of the area to be monitored and the identifier of the mobile terminal to be monitored; and
determining, according to invoicing rules, a tariff policy to be applied to a user of the mobile terminal to be monitored.

12. A non-transitory computer readable medium comprising a computer program product stored thereon, comprising program code instructions for implementing a detection method when the instructions are executed by a processor of an equipment monitoring use of resources of a radio communication network, wherein the instructions configure the equipment monitoring the use of the resources of the radio communication network, to detect underuse of the resources of at least one area to be monitored comprising at least one cell constituting a radio communication network by:
receiving, coming from an invoicing-rules management equipment, at least one identifier of the area to be monitored, and an identifier of at least one mobile terminal to be monitored present in the area to be monitored;
detecting underuse of the resources of the area; and
transmitting, to the invoicing-rules management equipment, the identifier of the area to be monitored, a parameter indicating underuse of the resources of the area to be monitored and the identifier of the mobile terminal to be monitored.

13. A non-transitory computer readable medium comprising a computer program product stored thereon comprising program code instructions for implementing a collection method according to claim 9, when it is executed by a processor.
